(19) United States
(12) Patent Application Publication
(10) Pub. No.: US 2023/0376821 A1
(43) Pub. Date: Nov. 23, 2023

(54) DIGITAL CIRCUITS FOR QUANTUM COMPUTERS IMPLEMENTATION OF QUBIT WITH CONTROLLABLE PROBABILITY OF STATES AND ALLOCATION OF ADJUSTABLE NOISE AND QUGATE WITH NOISE INJECTION

(71) Applicant: Eonum Inc., Irvine, CA (US)

(72) Inventor: Olga Vlasova, Irvine, CA (US)

(73) Assignee: Eonum Inc., Irvine, CA (US)

(21) Appl. No.: 17/745,870

(22) Filed: May 17, 2022

(51) Int. Cl. G06N 10/60

(52) U.S. Cl. CPC G06N 10/60

(57) ABSTRACT

The quantum computation principle is based on the phenomenon of superposition of states exhibited in specialized cells called quantum bits or qubits. Helped by quantum gates, the qubits can be connected into circuits with architectures determined by specific tasks. The result of quantum computation is extracted by measuring the probability for different combinations of qubits' states.

The invention describes the architecture of a digital circuit for behavioral implementation of quantum bit and quantum gate logic. Both quantum bit and quantum gate are needed for quantum computations. The invented circuits provide programmable control of quantum states superposition (states' probabilities) and the noise with a controllable level. This invention is a digital equivalent (asymptotic emulator) of a quantum bit and quantum gate. The design can work at room temperatures and be easily repeated (multiplied) in digital ASICs and FPGAs. The suggested circuits can drastically increase the number of qubits achievable in quasi quantum computers from hundreds to thousands. Additionally, the noise control in the invented circuit allows emulating both real and ideal (no noise) qubit behavior. Therefore the invention is well-suited for stochastic simulation technologies such as the dissipative approach in quantum field theory.

### BACKGROUND OF THE INVENTION

The quantum computation principle is based on the phenomenon of superposition of states exhibited in specialized cells called quantum bits or qubits. The superposition of states means the simultaneous presence of the qubit in both orthogonal states |0> and |1>, albeit with some probability, not necessarily equal for both conditions. The main difference between the quantum computations from the classical ones is that the superposition of qubit states varies the processed values, unlike the classical register bit with its just two states, 0 and 1.

With the help of quantum gates, the qubits can be connected into circuits with architectures determined by the specific tasks. Once quantum gates and bits are assembled together, they become quantum computers. The programs in these computers are effectively the connections between qubits and quantum gates. The computation results are extracted from the quantum computers by measuring the probability for different combinations of qubits states in the computer's circuits.

The most common approach to quantum computation is based on the usage of qubits implemented on physical phenomena such as the spin of electrons, the polarization of light, etc. Practically, any elementary particles with observable states can be used as qubits. However, some approaches to qubits' implementation require low temperatures to sustain the qubits'states intact. Others are not. But the current technology struggles with achieving the number of qubits in the quantum processor to be more than a hundred. In addition, the cooling equipment (for qubits based on fermions, such as electrons) or laser optics (for qubits based on bosons, such as photons) prevent effective miniaturization of the quantum computers.

The invented qubit circuit can tolerate ambient room temperatures. It is suitable for implementing the standard semiconductor technology used to manufacture Application-Specific Integrated Circuits (ASICs). The invented qubit circuit can also be prototyped on any Field Programmable Gate Array (FPGA) device, given that the FPGA device has enough classic gates and flops.

### BRIEF SUMMARY OF THE INVENTION

The quantum computation principle is based on the phenomenon of superposition of states exhibited in specialized cells called quantum bits or qubits. This superposition is viewed as the simultaneous presence of the qubit in both orthogonal states. The underlying idea of the invention is the next: the superposition of states can be considered a process where the qubit quickly switches between two orthogonal states |0> and |1> with some probability distribution between these two states. The faster the alteration of states—the closer the circuit's behavior is to the physical qubit device behavior. The invention describes the solution for qubit emulation, which can be implemented with digital chip technology. At digital clock frequencies above 2 GHz, the behavior of the digital emulator will be indistinguishable from its physical counterpart based on electron spin.

The invention allows building of quantum computers based on digital modules with standard semiconductor components. The target of quasi quantum computation is achieved by probability quantization of orthogonal states |0> and |1>, which can be modulated in a qubit as a superposition of states. The superposition of orthogonal states in the invented circuit also introduces the regulated noise conveniently implemented in the same quantizer of orthogonal states—one quantizer produces the programmable superposition of the states and an allocation of controllable noise.

A quantum computer is a network (connections) of qubits and quantum gates arranged in a specific way to address a particular task. Below is the description of the drawings depicting an example of qubit implementation (FIG. 1 and FIG. 2) and an example of two qubits connected to the controlled NOT gate called the CNOT gate (FIG. 3 and FIG. 4). Other types of quantum gates can be implemented similarly to the described CNOT example.

### BRIEF DESCRIPTION OF THE SEVERAL VIEWS OF THE DRAWING

FIG. 1 contains a simplified block diagram of the probability modulator, which comprises these main parts: linear feedback shift register 1, disturber 2, quantizer (comparator) 3.

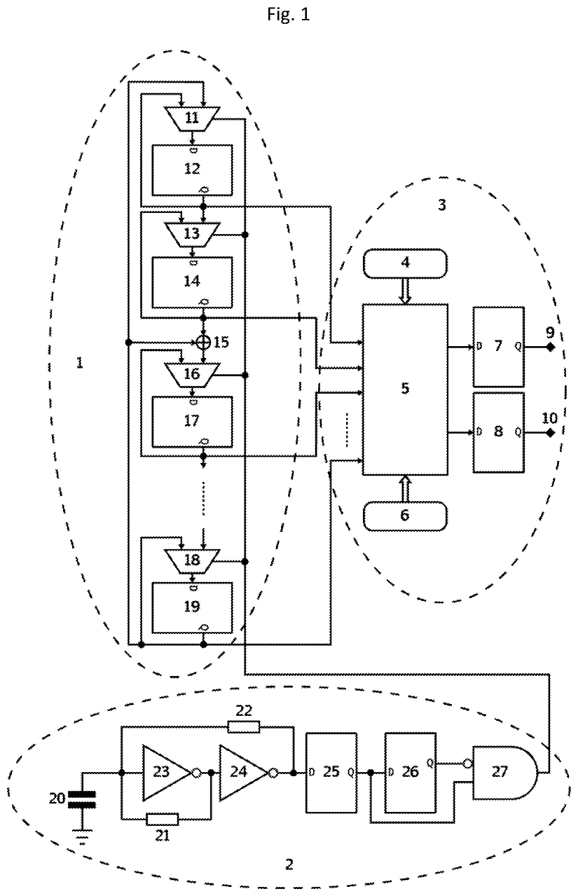

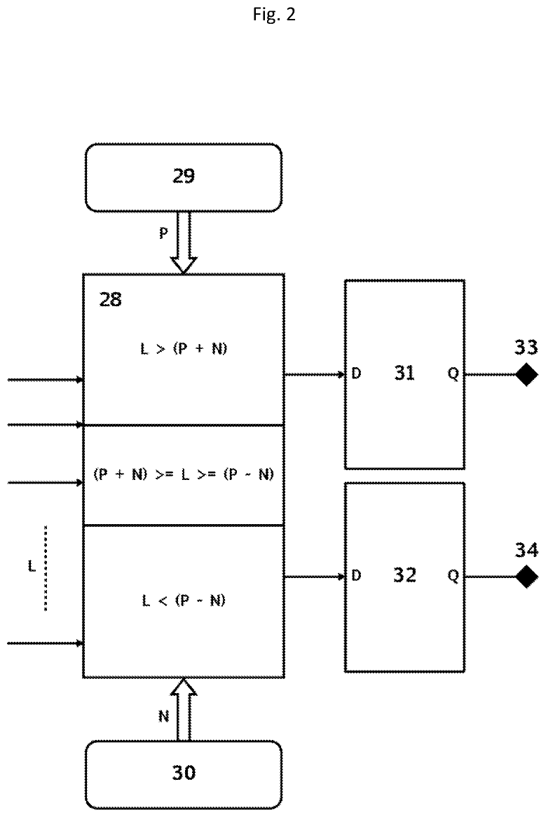

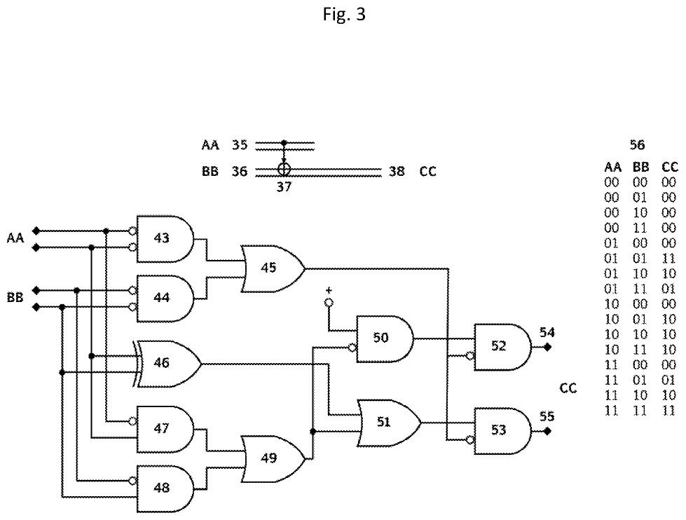

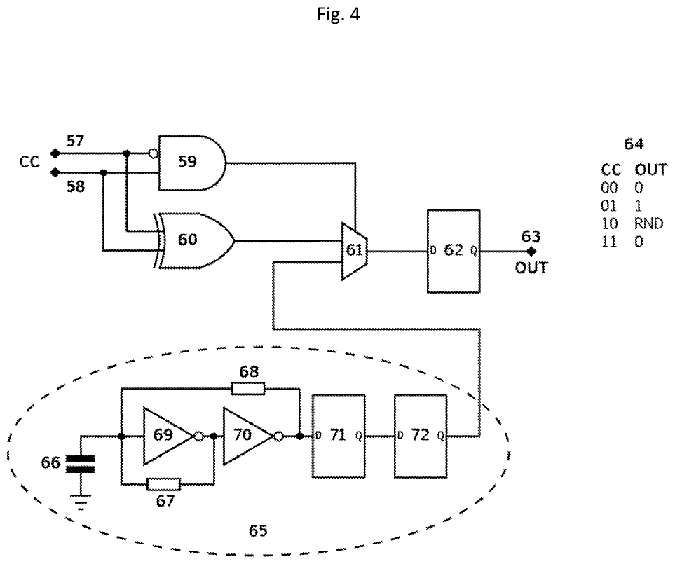

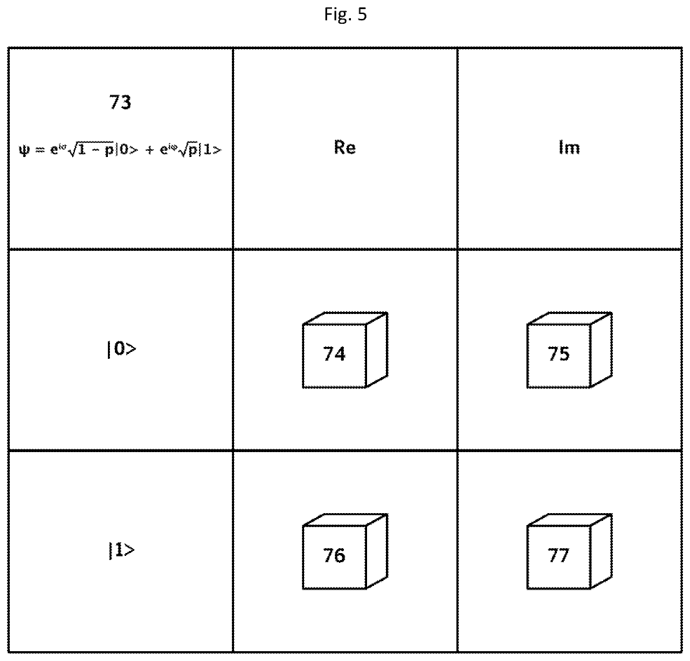

Linear feedback shift register 1 consists of m individual flip-flop bits, where number m is design dependent, typically 16. Only 4 flip-flops out of m bits are shown in FIG. 1. They are marked as 12, 14, 17, and 19. Linear feedback shift register 1 is a generator of pseudo-random numbers. Feedback is made via exclusive OR elements (XOR gates) shown in FIG. 1 as element 15.

A set of m multiplexers 11, 13, 16, and 18 has been added to generate a random number. The multiplexers are controlled by disturber 2 output. Disturber 2 comprises two inverters 23 and 24, two flip-flops 25 and 26, and logic AND gate 27. Inventor 23 acts as an RC oscillator whose period of oscillations is determined by capacitor 20 and resistor 21. Inventor 24 and resistor 22 form a Schmitt trigger for better transition stability of RC oscillator based on inventor 23. Flip-flops 25, 26, and logic gate 27 produce a single pulse on gate 27 every time there is a transition from logical 0 to logical 1 on the output of flip-flop 25. Gate 27 output pulses go to the multiplexers 11, 13, 16, and 18 preventing linear feedback register 1 from advancing to the new value at random moments of time. These events are truly random because the RC oscillator is independent of a clock used in flip-flops 12, 14, 17, 19, 25, and 26.

The current value of the linear feedback shift register 1 is compared in the quantizer 3 comparator 5 using values stored in two registers: 4 and 6. The programmable state probability setting register 4 and programmable possibility noise register 6 usages are presented in FIG. 2. The comparison results in the form of two bits going to flip-flops 7 and 8 and then to the outputs 7 and 8 of the quantizer and modulator as a whole.

FIG. 2 describes in detail the design of quantizer 3 from FIG. 1. The quantizer consists of comparator 28, programmable state probability setting register 29 (same as 4 in FIG. 1), and programmable probability noise register 30 (same as 6 in FIG. 1). The comparator 28 compares the current value in the linear feedback shift register (LFSR) shown as 1 in FIG. 1 with values stored in registers 29 and 30. Under the assumption that L represents the LFSR value, P represents value in the register 29, and N represents value in the register 30, the result of the comparison is coded in two bits:

L>(P+N) result is binary 11;

(P+N)>=L>=(P−N) result is binary 10;

L<(P−N) result is binary 01.

Two bits of the result go to inputs of two flip-flops: 31 (least significant bit) and 32 (most significant bit).

The flip-flops can also take the reset value of binary 00. So, on quantizer outputs 33 (same as 9 in FIGS. 1) and 34 (same as 10 in FIG. 1), all four binary combinations are possible 00, 01, 10, 11.

The combinations are treated as follows.

00—UNK (unknown state);

01—state |1>;

10—RND (random noise allocation: equally spread between state |1> or state |0>);

11 — state |0>.

Other variants of the assignment between binary coding and quantum state representations are allowed and equally suitable.

FIG. 3 describes a controllable NOT(CNOT) quantum gate that combines the states of two qubits (control qubit 35 and target qubit 36). The CNOT quantum gate 37 changes the state of the CNOT gate output 38 to the opposite (|0>->|1>; |1>->|0>) with respect to 36 only if the state of the control qubit 35 is |1>. This operation corresponds to the classic logical exclusive XOR operation. But the difference between a traditional XOR gate and a quantum CNOT gate is a reversible behavior of the quantum target qubit. The target qubit state 38 can be changed not only by CNOT gate inputs 35 and 36 but also by CNOT gate output 38 toward input 36 in the case the target qubit 36 is entangled with some other third qubit via output 38 of the CNOT gate, and that third remote qubit changes its state. This phenomenon of entanglement is the base for quantum communication.

The double line representing qubits 35 and 36 is specific to the invention because the quantizer 3 on FIG. 1 needs two classic bits to represent the qubit states |1>, |0>and random noise RND.

Each qubit is a combination of circuits 1, 2, and 3 on FIG. 1. This combination needs to be repeated twice: one time for qubit AA (35) and the second time for qubit BB (36). In both cases, the qubits'states are measured on outputs 9 and 10.

Table 56 represents the CNOT table where AA is the control qubit 35 states, BB is the target qubit 36 representation, and CC is the CNOT gate 38 output values.

Table 56 will be discussed in the detailed description of the invention. Meanwhile, gates 43, 44, 45, 46, 47, 48, 49, 50, 51, 52, 53 represent classic digital implementation of the table 56. Here inputs 39 and 40 comprise connections to the qubit AA (35), and inputs 41 and 42 form connections to the qubit BB (36).

Inputs 39 and 40 must be connected to the quantizer 3 outputs 9 and 10, respectively.

Inputs 41 and 42 must be connected to another quantizer 3, output 9, and output 10.

The output CC of the CNOT gate is measured on two classic bits, 54 and 55. These two bits go to the noise injection circuit in FIG. 4.

FIG. 4 depicts the noise injection circuit, which architecturally can be divided into two parts: multiplexor 61 and the random bit generator 65. The multiplexor 61 has a control logic based on AND gate 59, which switches the multiplexor to random bit value RND every time inputs 57 and 58 have binary values 0 and 1, respectively, representing allocation of the noise made by the qubits and combined by table 56 to the final result. Note that inputs 57 and 58 are connected to outputs 54 and 55, respectively, and helped by exclusive XOR gate 60, they implement table 64 in the form of the electronic circuit. Flip-flop 62 is used to synchronize the output of multiplexor 61 with output 63 OUT to the clock used for all other flip-flops in the design.

Random bit generator 65 architecturally is similar to the disturber 2 on FIG. 1. Nevertheless, 65 and 2 cannot be combined because they need to run independently from each other. Random bit generator 65 comprises two inverters, 69 and 67, and two flip-flops, 71 and 72. Inventor 69 acts as an RC oscillator whose period of oscillations is determined by capacitor 66 and resistor 67. Inventor 70 and resistor 68 form a Schmitt trigger for better transition stability of RC oscillator based on inventor 69. Flip-flops 71 and 72 form a chain of registers to produce a stable yet random bit value 0 or 1 on wire RND, which goes to multiplexor 61 for the noise injection into the final output 63 OUT. The value from output 63 OUT can go to other quantum gates for further data processing. It can also measure the state's superposition probability if this quantum gate is the final in the chain representing the quantum processor.

FIG. 5 is intended to show the implementation of a qubit for applications where quantum phase calculations are required. In comparison to the hardware of the qubit shown in FIG. 1, the resources need to be quadrupled 74, 75, 76, 77 for real (Re) and imaginary (Im) parts and for each quantum state |0> and |1> separately. The underlying formula 73, theory and reasoning will be discussed in the detailed description of the invention.

### DETAILED DESCRIPTION OF THE INVENTION

The invention describes the way to build digital components for quantum computation. The invented approach removes the most significant limitation for implementing quantum computers: the number of quantum bits per quantum computer. The count can be increased to thousands per device. Currently, quantum computers have no more than a hundred or so qubits.

The main goal of the invention is to implement the quantum computation principle using semiconductor technology suitable for miniaturization. The target is achieved by controlling qubits'states probability quantization of orthogonal states |0> and |1>, which can be modulated in a qubit as a superposition of states. The invention also allows adding noise with a controllable level to each qubit that matches the behavior of fundamental physical phenomena used in the lab quantum computers.

The invention describes a design for implementing a qubit and a structure of a quantum gate. These two modules are building materials to construct elaborate quantum computers.

The quantum bit (or qubit) architecture is depicted in FIG. 1. The idea is to generate a sequence of 0 and 1 randomly but with specific probability distribution between these two states. Every time someone measures the output of the qubit, the result is 0 or 1. However, after multiple measurements, the statistics for the qubit should show that zeros are more frequent than ones, or the opposite, or both are detected with equal rates. Noise should be added with a controllable level that widens the range of uncertainty for the probability distribution between states |0> and |1>. If the injected noise level is zero, the invented circuit becomes an equivalent of an “ideal” quantum qubit.

Architecturally, the invented qubit consists of three parts: linear feedback shift register 1, disturber 2, and quantizer 3.

Linear feedback shift register 1 produces pseudo-random m-bit numbers for every clock feeding register 1. The value of register 1 is shifted simultaneously in all flip-flops 12, 14, 17, and 19 of register 1. For example, the value of flip-flop 12 goes to flip-flop 14. Simultaneously the value of flip-flop 14 is transferred to the flip-flop 17 and so on until the last flip-flop 19, where it is returned (is fed back) to flip-flop 12 and to flip-flop 17 via exclusive XOR gate 15. The insertion of an XOR gate between flops 14 and 17 for feedback is given as an example. The actual width of the shift register and its feedback selection can differ from what is described above. There are underlying LSFR rules (which is public knowledge) for selecting the feedback architecture for the shift register to cover all 2m-1 numbers (except zero value). The line feedback shift register 1 can be initialized (seeded) to any non-zero value.

Disturber 2 sends pulses that randomly stop the linear feedback register from advancing to create a truly random set of numbers. To prevent the shift register from shifting, the multiplexors 11, 13, 16, and 18 are added to the input of each flip-flop. Every time disturber 2 generates a pulse with a duration of one clock, the multiplexors switch inputs of the flip-flops to their respective outputs. Thus, if the disturber's output is logical 1 for one clock, the line feedback shift register skips a shift for one clock.

The design of disturber 2 is based on the RC auto-generator implemented on inverter 23. The frequency f of the disturber's oscillation is a reciprocal of the RC product, where R is the resistor 21 value and C is the capacitance of capacitor 20. The frequency of the RC oscillator can be calculated as f=1/(RC). The optimal frequency for the disturber should be selected approximately 4 times slower than the frequency of the clock feeding the flip-flops. The fact that the oscillator is independent of clock feeding flip-flops of LSFR and dependent on temperature and voltage is beneficial for the true randomness of the oscillations.

Second inverter 24 in the disturber is needed to avoid jittering in the RC oscillator transitions. It provides positive stabilizing feedback on the input of inverter 23 via resistor 22. The value of resistor 22 should be approximately 10 times bigger than the value of resistor 21 in order not to suppress the oscillation itself.

The output of inverter 24 is connected to the flip-flop 25, which itself is connected to the input of flip-flop 26. With AND gate 27, the flip-flops 25 and 26 form a circuit that generates a pulse with a duration of 1 clock every time the output of flip-flop 25 has a transition from logical 0 to logical 1. It is achieved by inversion on the top input of AND gate 27. The circuit will also work if flip-flop 25 output transition from logical 1 to logical 0 is used. Here the second input of gate 27 should be inverted instead of the first input of gate 27.

After all, m-bit random numbers generated by a linear feedback shift register 1 and disturber 2 go to quantizer 3 for comparison with the m-bit value programmed in the probability setting register 4 and noise level setting register 6.

FIG. 2 describes in detail the design of quantizer 3 from FIG. 1. The quantizer consists of comparator 28, programmable state probability setting register 29 (same as 4 in FIG. 1), and programmable probability noise register 30 (same as 6 in FIG. 1). The comparator 28 compares the current value in the linear feedback shift register (LFSR) shown as 1 in FIG. 1 with values stored in registers 29 and 30. There are three ranges of comparison in the quantizer. Under the assumption that L represents the LFSR value, P represents value in the register 29, and N represents value in the register 30, the result of the comparison is coded in two bits:

L >(P+N) result is binary 11;

(P+N)>=L>=(P−N) result is binary 10;

L<(P−N) result is binary 01.

Two bits of the result go to inputs of two flip-flops, 31 (least significant bit) and 32 (most significant bit). The flip-flops can also take the reset value of binary 00. So, on quantizer outputs 33 (same as 9 in FIGS. 1) and 34 (same as 10 in FIG. 1), all four binary combinations are possible 00, 01, 10, 11.

The combinations are treated as follows.

00—UNK (unknown state);

01—state |1>;

10—RND (random noise: equally spread between state |1>or state |0>);

11—state |0>.

Other variants of the assignment between binary coding and quantum state representations are allowed and equally suitable.

If the LSFR is m-bit wide, it generates 2^{m}−1 random numbers. Thus, the probability of state |1> is (P−N)/(2^{m}−1), probability of state |0> is (1−P−N)/(2^{m}−1). The likelihood of noise is the rest 2N/(2^{m}−1).

FIG. 3 illustrates quantum gate usage where two qubits 35 and 36 are connected via controllable NOT (or CNOT) gate 37 with the result of the function going to output 38. The CNOT quantum gate combines the states of two qubits. They are called: control qubit 35 and target qubit 36. The CNOT quantum gate 37 changes the state of the CNOT gate output 38 to the opposite (|0>->|1>; |1>->|0>) with respect to 36 only if the state of the control qubit 35 is |1>. This operation corresponds to the classic logical exclusive XOR operation. But the difference between the traditional XOR gate and quantum CNOT gate is a reversible behavior of the quantum target qubit. The target qubit state 38 can be changed not only by CNOT gate inputs 35 and 36 but also by CNOT gate output 38 toward input 36 in the case the target qubit 36 is entangled with some other third qubit via output 38 of the CNOT gate, and that third remote qubit changes its state. This phenomenon of entanglement is the base for quantum communication. The double line representing each qubit 35 and 36 is specific to the invention because the quantizer 3 on

FIG. 1 needs two classic bits to represent the qubit states |1>, |0> and random noise RND, which equally spreads to the states |1> and |0>.

Each qubit is a combination of circuits 1, 2, and 3 on FIG. 1. To create two independent quantum bits, AA and BB, all parts from FIG. 1 need to be repeated twice: one time for qubit AA (35) and the second time for qubit BB (36). The qubits'states are taken from outputs 9 and 10 separately for qubits AA and BB.

Table 56 represents the CNOT function table where column AA is the control qubit 35 states, column BB is the target qubit 36 representation, and column CC depicts the values of the CNOT gate 38 output.

Table 56 for the invention-specific CNOT gate is extended to accommodate decoding the random state RND and unknown state UKN besides two orthogonal states |0> and |1>.

If an unknown state UNK (binary 00) is presented on the inputs AA or BB of the CNOT gate, the output CC is assigned to the UNK state (binary 00).

If an unknown state RND (binary 10) is presented on the inputs AA or BB of the CNOT gate, the output CC is assigned to the RND state (binary 10).

In all other cases the output CC is an exclusive OR (XOR) function of AAand BB in notation that binary 11 represents logical 0 and binary 01 represents logical 1. Thus 01\hat{ }11=01; 11\hat{ }01=01; 11\hat{ }11=11; 01\hat{ }01=11, where \hat{ } represents an exclusive or in basis binary 11 (logical 0) and binary 01 (logical 1).

Gates 43, 44, 45, 46, 47, 48, 49, 50, 51, 52, 53 on FIG. 3 represent the classic digital implementation of table 56. Here inputs 39 and 40 comprise connections to the qubit AA (35), and inputs 41 and 42 form connections to the qubit BB (36).

Inputs 39 and 40 must be connected to the qubit AA quantizer 3 outputs 9 and 10.

Inputs 41 and 42 must be connected to another qubit BB quantizer 3 outputs 9 and 10.

The output CC of the CNOT gate is measured on two classic bits: 54 and 55. These two bits go to the noise injection circuit in FIG. 4.

FIG. 4 depicts a noise injection circuit that architecturally can be divided into multiplexor 61 and the random bit generator 65. The multiplexor 61 has a control logic based on AND gate 59, which switches the multiplexor to random bit value RND every time inputs 57 and 58 have binary values 0 and 1, respectively, representing allocation of the noise made by the qubits and combined by table 56 to the final result. Note that inputs 57 and 58 are connected to outputs 54 and 55, respectively. Table 64 is implemented as an exclusive XOR gate 60. Flip-flop 62 is used to synchronize the output of multiplexor 61 with output 63 OUT by the clock used for flip-flops in the LSFR.

Architecturally, the random bit generator 65 is similar to the disturber 2 on FIG. 1. Random bit generator 65 runs independently from the disturber 2. Random bit generator 65 comprises two inverters, 69 and 67, and two flip-flops, 71 and 72. Inventor 69 acts as an RC oscillator whose period of oscillations is determined by capacitor 66 and resistor 67. Inventor 70 and resistor 68 form a Schmitt trigger for better stability of RC oscillator based on inventor 69. Flip-flops 71 and 72 form a chain of registers to produce a stable yet random bit value 0 or 1 on wire RND, which goes to multiplexor 61 for the noise injection to the final output 63 OUT. The value from the production OUT can go to other quantum gates for further data processing, or it can measure the state's superposition probability if this quantum gate is the final in the chain representing the quantum processor.

FIG. 5 addresses the cases where quantum phase calculations are required. Typically, such quantum algorithms include the evaluation of functions with some weight coefficients. Quantum phase shift is used as a representation of the weight values. In general, the quantum phase is another degree of freedom for quantum bit states besides the real part of probability. The generalized wave function 73 has the following representation ψ=e^{iσ}\sqrt{1−p}|0 [symbol] +e^{iφ}\sqrt{p}|1 [symbol] where each orthogonal state has its own weight coefficients in both real and imaginary spaces. Here, p is the probability of state |1>, while σ and φ are quantum phases for states |0> and |1>, respectively. If a specific quantum algorithm task does not require phase shifts—the angles σ and φ can be set to 0. As a result, the above wave function can be simplified to the following form: ψ=e^{iσ}\sqrt{1−p}|0 [symbol] +e^{iφ}\sqrt{p}|1 [symbol] . This wave function corresponds to the simplified qubit implementation shown in FIG. 1, which for wave function with phases needs to be quadrupled for real (Re) and imaginary (Im) parts and for each of quantum states |0> and |1>. And it should be done separately to add quantum phases independently from each other. In total, four repetitions of the hardware shown in FIG. 1 are required to create the universal qubit representation. FIG. 5 reflects this quadrupling of the circuits as 74, 75, 73 and 77.

The substitute specification contains no new matter.

We claim:

1. A circuit of quantum bit (qubit) for the generation of a random sequence with the ability to change the probability of a superposition of two orthogonal states |0> and |1> and with a controllable noise allocation. The circuit of a qubit is comprised of:
a. a linear shift m-bit register generating 2^{m}−1 numbers;
b. a random disturber stopping the linear shift register from advancing at a rate slower than the linear shift register clock;
c. an m-bit register for storing a value of the desired probability of the orthogonal states;
d. an m-bit register for the setting of the desired level of noise; and
e. a multilevel quantizer (arithmetical comparator between the current value of the linear shift register and the value stored in the programmable m-bit register for the probability of states), driving the output of the qubit to the orthogonal states |0> and |1> proportionally to the programmed probability and allocating the desirable noise level according to the setting in the second m-bit register.

2. A circuit for implementing a quantum gate for combining orthogonal states |0> and |1> of the multiple qubits and with an ability to inject random noise. The circuit of the quantum gate is a combination of:
a. a classic function gate XOR, OR, AND, etc.;
b. a quantum gate noise injection circuit based on the allocation of noise from qubits' settings;
c. a random bit generator as a source of the allocated noise for the quantum gate.

3. A combination of the above circuits for implementing a quantum bit and quantum gate with the ability to serve both probability and quantum phase functionality.
